(19) United States
(12) Patent Application Publication
(10) Pub. No.: US 2006/0113920 A1
(43) Pub. Date: Jun. 1, 2006

(54) Plasma display panel and drive method thereof

(76) Inventors: Hoon-Young Choi, Suwon-si (KR); Min Hur, Suwon-si (KR); Young-Do Choi, Suwon-si (KR); Mizuta Takahisa, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/266,825

(22) Filed: Nov. 4, 2005

(30) Foreign Application Priority Data
Nov. 26, 2004 (KR) 10-2004-0097902

(51) Int. Cl. G09G 3/10

(52) U.S. Cl. 315/169.3; 315/169.4

(57) ABSTRACT

A plasma display panel includes a plurality of discharge cells used to realize the display of images by gas discharge. The plasma display panel is divided into a display region where images are displayed and a non-display region where display does not occur. The plasma display panel includes first electrodes, second electrodes, and third electrodes intersecting the first and second electrodes. Fourth and fifth electrodes are formed in the non-display region spaced apart from each other. In a method of driving a plasma display panel, a voltage is applied at least one time to each of the fourth and fifth electrodes prior to applying a scan voltage to the second electrode that is scanned lastly among the second electrodes.

### CROSS REFERENCE TO RELATED APPLICATION

This application claims priority to and the benefit of Korean patent application No. 10-2004-0097902 filed in the Korean Intellectual Property Office on Nov. 26, 2004, the entire disclosure of which is incorporated herein by reference.

### BACKGROUND

1. Field

The present invention relates to a plasma display panel (PDP), and more particularly to a PDP and a method for driving the same.

2. Discussion of the Related Technology

A PDP is a display device that realizes the display of images through excitation of phosphors by plasma discharge. Ultraviolet (UV) lights emitted from plasma obtained via gas discharge excite phosphors, which then emit visible light to form images. The PDP has many advantages over other information display devices. The advantages of PDPs include the production of large screens such as 60 inch screens or even larger, a thin profile of 10 cm or less, good color reproducibility due to the self-emissive nature of the PDP (as in the case of cathode-ray tubes), and minimal color distortions with change of the viewing angle. Furthermore, high productivity and low manufacturing costs are realized with PDP technology as a result of production processes that are simpler than those involved with liquid crystal displays. As a result, the PDPs become increasingly popular.

The PDP's fundamental structure was developed in the 1970s. The most common configuration in use today is that of the triode surface discharge structure. The PDP employing the triode surface discharge structure includes a front substrate and a rear substrate apart from each other with a predetermined gap therebetween. A discharge gas is sealed in the gap. Display electrodes are formed on the front substrate, and address electrodes are formed on the rear substrate along a direction intersecting the display electrodes. Discharge is controlled by scan electrodes, which are independently operated through connection to each line, and by the address electrodes provided opposing the scan electrodes. Sustain discharge, which controls brightness, is realized by pairs of electrodes positioned generally in the same plane close to the front substrate.

Considering luminescence principles in the PDP, wall charges accumulate on a dielectric layer through address discharge effected between the address electrodes and the scan electrodes. The wall charges act to reduce a discharge firing voltage needed for sustain discharge. Further, by alternating current signals applied to the display electrodes, sustain discharge occurs in discharge cells selected during an address period. UV light is generated during the process of discharge in the discharge cells. The UV light excites red, green, and blue phosphors so that they emit visible light. Emitting visible lights from a number of discharge cells arranged in a matrix realizes the display of images on the matrix.

AC surface discharge PDP devices display images using an address display separated (ADS) driving scheme. A frame, which is the smallest unit making up an image, is divided into eight or more subfields according to gray scale. Each of the subfields is comprised of a reset period, an address period, and a sustain period. Typically, the time length of the reset and address periods are identical, but the time length of the sustain period differs from subfield to subfield. Accordingly, depending on the relative brightness in the sustain period, 2ⁿ gray scales may be displayed in each subfield.

In PDP devices operating as above, two methods are often used in order to obtain stable discharge characteristics during address discharge: utilizing an address discharge pulse width of 2.5 μs or greater for each subfield, or increasing a voltage level of the discharge pulse. If the voltage level of the address discharge pulse is low, discharge strength and the amount of charged particles are low. Thus, the degree to which voltage levels may be reduced is limited. If the discharge pulse width is at least 2.5 μs, assuming a time period for one frame to be set to 16.67 ms, the time length of the sustain period would be 30% or less of the total time of one frame. Hence, screen brightness can be reduced as the sustain period is a determining factor for the brightness. In addition, increasing addressing time will further limit high speed addressing in large screen PDPs. For example, in a high definition PDP with 1920×1080 pixels, the total time required to scan the discharge cells from the first row to the last row (1,080th row) is approximately 2.7 ms (1,080×2.5 μs). Accordingly, the discharge cells that are scanned later in the addressing period may not be properly selected. This is because priming charges (freely moving charges) that are created during the reset period and help selection of discharge cells during the address period, would most likely dissipated when the later-scanned discharge cells are scanned.. To avoid the non-selection, addressing time of each row can be lengthened to create sufficient address discharge, which can cause signal distortion.

### SUMMARY OF CERTAIN INVENTIVE ASPECTS

One aspect of the present invention provides a PDP and a method for driving the same, in which stable high-speed addressing in the PDP is made possible.

In a plasma display panel that utilizes a plurality of discharge cells defined between a front substrate and a rear substrate opposing each other to realize the display of images by gas discharge, the plasma display panel being divided into a display region where images are displayed by an independent discharge cell structure and a non-display region where display does not occur, the plasma display panel includes a plurality of first electrodes, a plurality of second electrodes, and a plurality of third electrodes arranged in the display region, the plurality of third electrodes being formed along a direction intersecting the plurality of first electrodes and the plurality of second electrodes, and including a discharge electrode arranged in the non-display region.

An auxiliary cell is formed by barrier ribs in the non-display region, the auxiliary cell being formed as at least one single independent space.

The non-display region is adjacent to a row of the discharge cells where addressing last occurs.

The barrier ribs may be extended along a direction in which the discharge electrode is extended, the barrier ribs defining the auxiliary cell as a single passageway along the same direction.

Vertical barrier ribs that define discharge cells of different colors are included in the display region. The vertical barrier ribs may extend into the auxiliary cell of the non-display region.

The discharge electrode includes a fourth electrode and a fifth electrode that correspond to the auxiliary cell in position and that are spaced apart from each other by a predetermined distance. The fourth and fifth electrodes are preferably made of a metal material.

The fourth and fifth electrodes may be formed on the front substrate in a stripe pattern together with the first and second electrodes.

A discharge that occurs in the auxiliary cell is significantly weaker than discharges that occur in the discharge cells. Preferably, a periodic discharge occurs in the discharge cell during an address period.

According to a method of driving a plasma display panel of the present invention, a field is divided into a plurality of subfields, at least one of the subfields including the step of initializing each discharge cell in the display region, the step of selecting discharge cells to be turned on, and the step of maintaining a discharge of selected discharge cells, wherein the discharge cells are divided into first discharge cells and second discharge cells, and the discharge occurs at least in a part of the non-display region prior to selecting the second discharge cells.

The second discharge cells correspond to first electrodes which are selected last among the first electrodes.

The second discharge cells correspond to first electrodes which are disposed close to the part of the non-display region.

A discharge in the part of the non-display region occurs right prior to selecting the second discharge cells.

Further, the discharge in the part of the non-display region occurs by applying a first voltage and a second voltage to the fourth electrode and the fifth electrode, respectively.

In addition, a difference between the first voltage and the second voltage is greater than a discharge firing voltage between the fourth electrode and the fifth electrode.

During an address period, the voltage applied to the fourth and fifth electrodes may be applied thereto periodically.

Further, during a reset period, a reset pulse identical to a reset pulse applied to the second electrodes may be applied to the fourth and fifth electrodes, and the reset pulse may be applied to the fourth and fifth electrodes periodically during the address period.

### BRIEF DESCRIPTION OF THE DRAWINGS

FIG. 1 is a schematic plan view used to describe display and non-display regions of a plasma display panel according to a first exemplary embodiment of the present invention.

FIG. 2 is a fragmentary exploded perspective view of the plasma display panel of the first exemplary embodiment of the present invention.

FIG. 3 is a sectional view taken along line III-III of FIG. 2, illustrating the plasma display panel in an assembled state.

FIG. 4 is a schematic plan view used to describe the arrangement of elements of the plasma display panel of FIG. 2 in the display and non-display regions.

FIG. 5 is a schematic view used to describe the arrangement of barrier ribs, display electrodes, and discharge electrodes of a plasma display panel according to a second exemplary embodiment of the present invention.

FIG. 6 is a block diagram showing an example of a driving device used to operate the plasma display panel according to an embodiment of the present invention.

FIG. 7 shows an example of drive waveforms used to drive the plasma display panel according to an embodiment of the present invention.

### DETAILED DESCRIPTION OF EMBODIMENTS

Exemplary embodiments of the present invention will now be described with reference to the drawings.

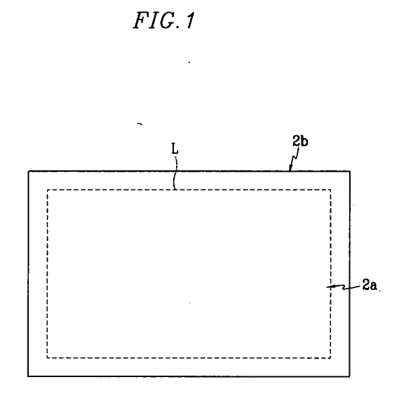

FIG. 1 is a schematic plan view used to describe display and non-display regions of a plasma display panel (PDP) according to a first exemplary embodiment of the present invention.

The PDP of the illustrated embodiment includes a display region 2a in which display of images takes place, and a non-display region 2b surrounding or next to the display region 2a with an imaginary boundary line L. Included in the display region 2a, as will be described in detail below, are display electrodes and phosphor layers provided in a structure corresponding to independently formed discharge cells. UV light is generated by gas discharge occurring in the discharge cells, and the UV light excites the phosphor layers, which then emits visible light. The non-display region 2b forms an outer periphery of the PDP from the perimeter of the display region 2a. The non-display region 2b includes a minimal discharge space and discharge electrodes. As a result, priming charges obtained through a weak discharge are accumulated in the non-display region 2b, and the priming charges are freely supplied to rows of discharge cells when addressing occurs relatively late.

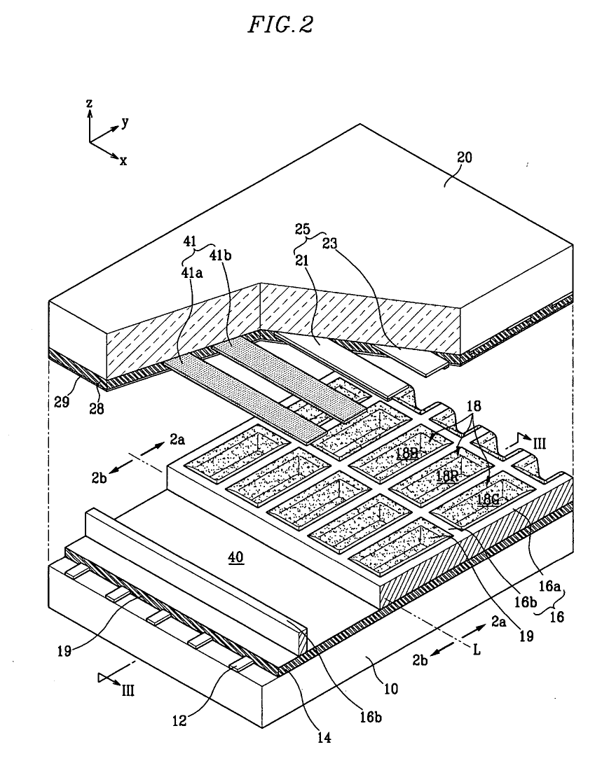

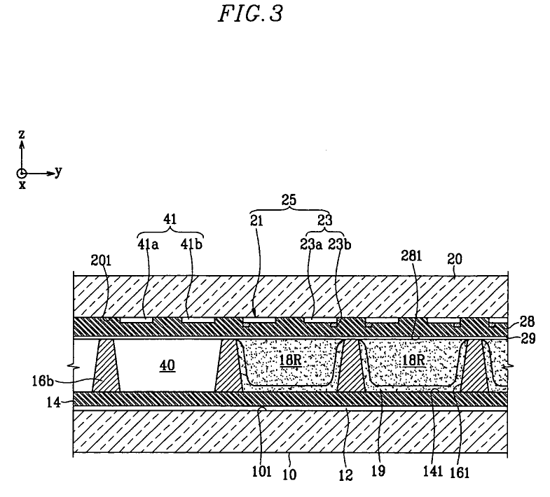

FIG. 2 is a fragmentary exploded perspective view of the plasma display panel of the first exemplary embodiment of the present invention, and FIG. 3 is a sectional view taken along line III-III of FIG. 2 illustrating the plasma display panel in an assembled state. An internal structure of the display region 2a of FIG. 1 will be described in detail with reference to FIGS. 2 and 3.

As shown in the drawings, the PDP according to an exemplary embodiment of the present invention includes a first substrate 10 (hereinafter referred to as a rear substrate) and a second substrate 20 (hereinafter referred to as a front substrate) provided opposing each other with a predetermined gap therebetween. Third electrodes 12 (hereinafter referred to as address electrodes) are formed on the rear substrate 10 along a first axis (y axis in the drawings). Barrier ribs 16 are formed between the rear and front substrates 10 and 20. The barrier ribs 16 define a plurality of discharge cells 18, which, according to the color of light emitted therefrom, may be designated by reference numerals 18R (for red), 18G (for green), and 18B (for blue). Phosphor layers 19, which are excited by UV light to emit visible light, are formed respectively in the discharge cells 18 covering a bottom surface 141 of each of the discharge cells 18, as well as side wall surfaces 161 of the barrier ribs 16. A discharge gas (e.g., a compound gas including xenon and neon) is filled in the discharge cells 18.

The front substrate 20 is made of a transparent material such as glass to allow for the transmission of light therethrough for the display of images. Display electrodes 25 are formed on an inner surface 201 of the front substrate 20, extending along a second axis ( x axis in the drawings). The display electrodes 25 are positioned corresponding to the discharge cells 18. Each of the display electrodes 25 is comprised of first electrodes 21 (scan electrodes) and second electrodes 23 (sustain electrodes). The scan electrodes 21 operate with the address electrodes 12 to select the discharge cells 18 to be turned on, and the sustain electrodes 23 operate with the scan electrodes 21 to effect sustain discharge in the selected discharge cells 18.

The display electrodes 25 are covered by a dielectric layer 28, which is made of a dielectric material such as PbO, B₂O₃, and SiO₂. The dielectric layer 28 acts to protect the display electrodes 25 from damage that would otherwise occur by the direct collision of charged particles with the display electrodes 25 during discharge, and also acts to induce the charged particles.

An inner surface 281 of the dielectric layer 28 that faces the rear substrate 10 is covered by a protection layer 29 made of, for example, MgO. The protection layer 29 protects the dielectric layer 28 from damage that would otherwise occur by the direct collision of charged particles with the dielectric layer 28 during discharge. The protection layer 29 emits secondary electrons when charged particles collide therewith such that the protection layer 29 enhances discharge efficiency.

The address electrodes 12 are formed on an inner surface 101 of the rear substrate 10 opposing the front substrate 20. The address electrodes 12 are extended along the y axis intersecting the display electrodes 25 as described above. Further, the address electrodes 12 are separated from each other and positioned corresponding to the discharge cells 18 in location. The address electrodes 12 are covered by a dielectric layer 14, and the barrier ribs 16 are formed in a predetermined pattern on the dielectric layer 14.

The barrier ribs 16 partition the discharge cells 18 and prevent crosstalk from occurring between adjacent discharge cells 18. The barrier ribs 16 include vertical (or first) barrier ribs 16a extending along the y axis and horizontal (or second) barrier ribs 16b extending along the x axis and thereby intersecting the vertical barrier ribs 16a. The intersection between the vertical and horizontal barrier ribs 16a and 16b a matrix of discharge cells 18. It is notable that although not illustrated, the barrier rib may be formed in other configurations, such as a stripe pattern along the y axis only.

The phosphor layers 19 are formed in the discharge cells 18 as described above. The phosphor materials of the layers 19 are excited by UV light that is generated during discharge and emit visible light. As shown in the drawings, the phosphor layers 19 are formed over side walls of the barrier ribs 16 and the dielectric layer 14 within the discharge cells 18. Each of the phosphor layers 19 may be formed with one of red, green, or blue phosphors, which determines differently colored discharge cells 18R, 18G, and 18B. A discharge gas in which neon (Ne) and xenon (Xe), etc. are mixed is filled in the discharge cells 18 as described above.

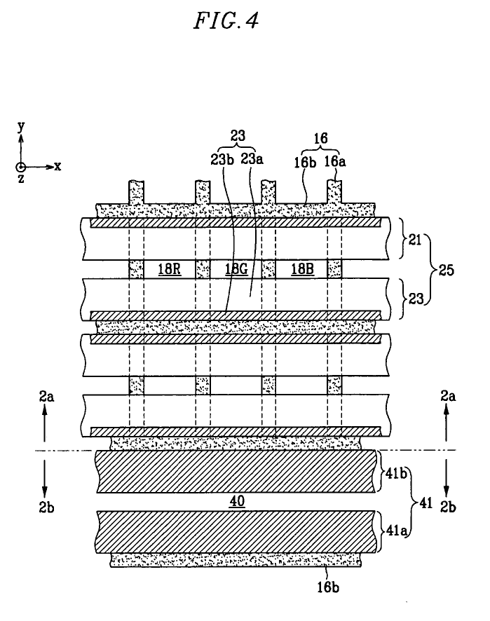

A discharge space is formed in the non-display region 2b (see FIG. 2), which is positioned outwardly from and adjacent to the display region 2a. This discharge space is formed with a minimum structure required for discharge. The non-display region 2b is formed adjacent to and aligned with the most peripheral row of the discharge cells 18. For example, if addressing of the rows is performed along the y axis, more particularly in the direction from the region 2a toward the region 2b in FIG. 4, the non-display region 2b is formed horizontally (i.e., along the x axis in FIG. 4) next to the last-addressed discharge cells 18, which are the lowermost row in FIG. 4.

The non-display region 2b forms an independent discharge space by a pair of the horizontal barrier ribs 16b, and is also defined by the discharge cells 18 of the adjacent display region 2a. The horizontal barrier rib 16b formed in the non-display region 2b opposes the last horizontal barrier rib 16b of the display region 2a with a predetermined distance therebetween. The horizontal barrier rib 16b formed in the non-display region 2b extends along the x axis. Accordingly, a sealed auxiliary cell 40 is formed between the horizontal barrier ribs 16b and is separated from the discharge cells 18 of the display region 2a. Although display does not occur in the auxiliary cells 40, discharge occurs therein to thereby result in the accumulation of framing charges.

A pair discharge electrodes 41 are formed over the auxiliary cell 40. The discharge electrodes 41 are described in detail below.

A weak discharge (i.e., a significantly weaker discharge than the discharges in the discharge cells 18) occurs in the auxiliary cell 40 during the address period. Priming charges generated by such a weak discharge are freely supplied to the adjacent discharge cells 18 of the display region 2a. This compensates for the loss of priming charges accumulated during the reset period. Therefore, in the discharge cells 18 where addressing occurs substantially later than in the rows of the discharge cells 18 where it first occurs, the problem of increased addressing time can be overcome.

FIG. 4 shows the arrangement of elements in the display and non-display regions 2a and 2b. The address electrodes 12 are omitted from the configuration to better illustrate the interrelationship of the other elements.

With reference to FIG. 4, the discharge cells 18 forming the display region 2a are formed in a matrix configuration with horizontal barrier ribs 16b extending along the x axis, and vertical barrier ribs 16a extending along the y axis. Further, the display electrodes 25 extend along the x axis at locations corresponding to the discharge cells 18.

The display electrodes 25 are comprised of a plurality of pairs of a sustain electrode 23 and a scan electrode 21. The pairs of the sustain electrodes 23 and the scan electrodes 21 extend along the x axis over rows of the discharge cells 18. In the illustrated embodiment, a pair of the sustain electrode 23 and the scan electrode 21 are positioned over a row of discharge cells 18 with a predetermined spacing therebetween. The display electrodes 25 are coupled to scan electrode and sustain electrode drivers 600 and 700, which provide electrical signals to the electrodes of each of the discharge cells 18.

In the illustrated embodiment, the sustain electrodes 23 and the scan electrodes 21 are identically formed. For the sake of convenience, only the sustain electrodes 23 will be described below, and the same can be applied to the scan electrodes 21.

In one embodiment, the sustain electrodes 23 includes a transparent electrode 23a and a metal electrode 23b. The transparent electrode 23a is formed in a stripe shape along one direction, i.e., along the x axis, which intersects the address electrodes 12. The transparent electrode 23a is made of a substantially transparent material such as ITO (indium tin oxide) so that light emitted from the discharge cells 18 can pass therethrough. However, the transparent material has generally low conductivity. The metal electrode 23b connected to the transparent electrode 23a compensates for the deficiency of low conductivity.

The metal electrodes 23b are formed, for example, in the shape of a bar along the direction in which the transparent electrodes 23a are extended. Further, so that the light emitted from the discharge cells 18 is not blocked significantly, the metal electrodes 23b are formed, for example, along an edge of the transparent electrode 23a and are positioned over the barrier ribs or very closely thereto. The metal electrodes 23b are formed as thin films using a highly conductive material, such as chrome, copper, or silver.

Meanwhile, as discussed above, the auxiliary cell 40 in the non-display region 2b is defined by a pair of horizontal barrier ribs 16b. That is to say, one of the pair defines the discharge cells 18 in the display region 2a, and the other of the pair is spaced apart from the one of the pair by a predetermined distance to thereby define the auxiliary cell 40. As illustrated, the auxiliary cell 40 is formed adjacent to the last row of the discharge cells 18 in the display region 2a.

As described above, the pair discharge electrodes 41 is formed on the front substrate 20 corresponding to the auxiliary cell 40 in location. The discharge electrode pair 41 is comprised of a fourth electrode 41a and a fifth electrode 41b. The fourth electrode 41a and the fifth electrode 41b extend along the x axis, that is, along the direction in which the auxiliary cell 40 extends. The discharge electrodes 41 are coupled to a discharge electrode driver 800, which will be described in detail below. The discharge electrode driver 800 applies electrical signals to the discharge electrodes 41 to effect a weak discharge during an address period.

The discharge electrodes 41 can be formed in any configuration suitable to realize a weak discharge. In the illustrated embodiment, the discharge electrodes 41 are configured in a stripe shape with a significant surface area facing the auxiliary cell 40. The fourth electrode 41a and the fifth electrode 41b of the discharge electrodes 41 are separated from each other with a predetermined spacing therebetween as a discharge gap. Further, since it is unnecessary to generate visible light in the auxiliary cell 40, the discharge electrode 41 may be made of a conductive metal material (i.e., a non-transparent material) such that discharge firing voltage may be further reduced.

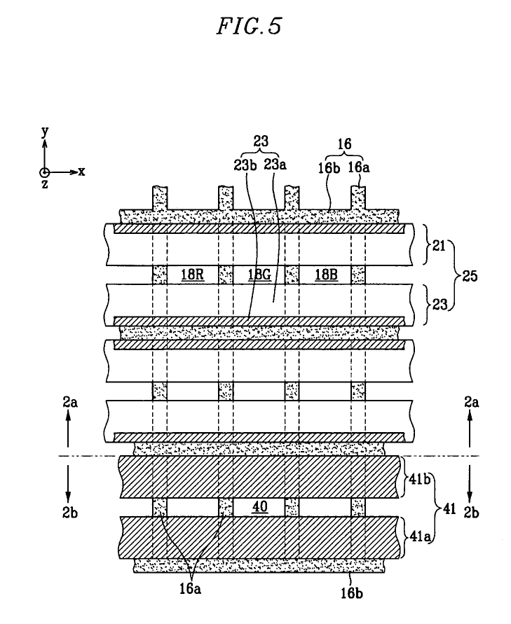

In FIG. 4, the auxiliary cell 40 is shown as a single unit with no obstruction along a length thereof. However, as shown in FIG. 5, the vertical barrier ribs 16a may extend into the auxiliary cell 40 to thereby separate the auxiliary cell 40 into a plurality of spaces.

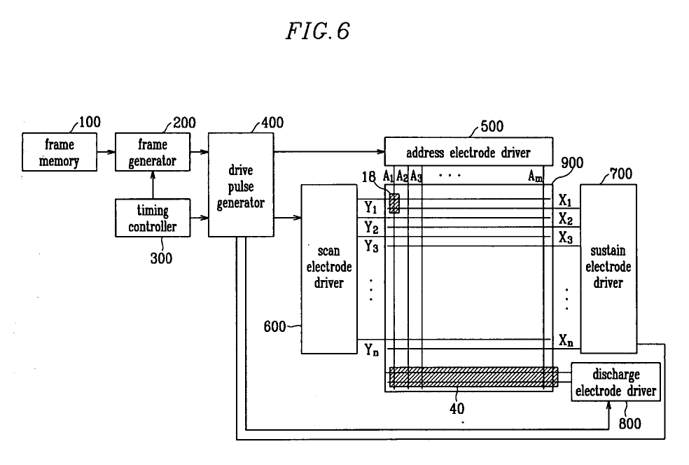

An exemplary operation of the illustrated PDP device will now be described. FIG. 6 is a block diagram illustrating a plasma display device with the above-described features of the embodiments.

With reference to FIG. 6, the plasma display device includes a frame memory 100, a frame generator 200, a timing controller 300, a drive pulse generator 400, an address electrode driver 500, the scan electrode driver 600, the sustain electrode driver 700, the discharge electrode driver 800, and a PDP 900.

In one embodiment, analog image signals for display on the PDP 900 can be converted to digital data and stored in the frame memory 100.

The frame generator 200 partitions the digital data stored in the frame memory 100 and outputs the data to the drive pulse generator 400 as needed. For example, pixel data is stored in the frame memory 100 according to gray scale levels for the display of gray scales on the PDP 900, and the frame generator 200 divides one frame of this pixel data into a plurality of subfields, and outputs data of each of the subfields.

The timing controller 300 generates various timing signals needed for the operation of the frame generator 200 and the drive pulse generator 400.

The drive pulse generator 400 receives frame generator signals from the frame generator 200 and timing signals output from the timing controller 300. With the inputted signals, and the drive pulse generator 400 generates signals for driving the scan and sustain electrode drivers 600 and 700 and the discharge electrode driver 800, and also generates address signals for driving the address electrode driver 500 to thereby generate signal waveforms for each electrode in the reset period, address period, and sustain period.

Further, the drive pulse generator 400 generates discharge signals for driving the auxiliary cell 40 of the PDP 900. For example, in the address period, the drive pulse generator 400 periodically transmits a discharge signal (e.g., every 25 rows) to the discharge electrodes 41 of the auxiliary cell 40 following the scan operation with respect to the discharge cells 18 of the display region 2a to thereby effect discharge in the auxiliary cell 40. Accordingly, the discharge cells 18, where the addressing takes place relatively late, receive priming charges, which otherwise would have been eliminated by the passage of time, from the adjacent auxiliary cell 40 such that stable addressing drive is made possible.

In addition, the drive pulse generator 400 generates a reset signal that initializes the state of each of the discharge cells 18, an address signal for selecting the discharge cells 18 to be turned on to thereby perform addressing, and a sustain signal for effecting discharge in the discharge cells 18 that have undergone addressing.

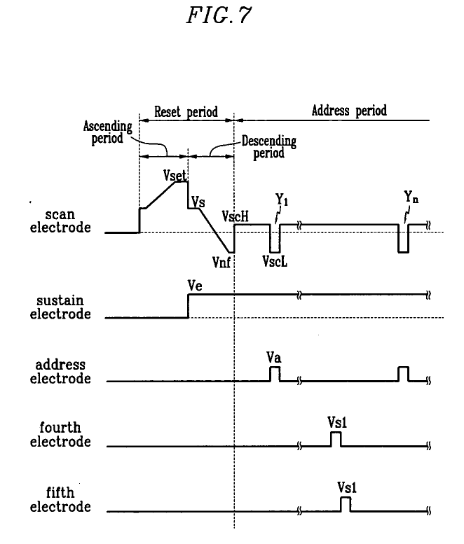

Drive waveforms applied to each of the electrodes will be described with reference to FIG. 7. Drive waveforms are applied to the fourth electrode 41a and the fifth electrode 41b prior to the sustain period (not shown). The drive waveforms applied to the scan electrodes 21, the sustain electrodes 23, and the address electrodes 12 do not change and are well appreciated by skilled artisan in the field.

In the following, “wall charges” refer to the charges formed on walls (e.g., on the dielectric layer) of discharge cells in proximity to each of the electrodes and considered as accumulated on the electrodes. Although such wall charges do not actually contact the electrodes, the wall charges are described as being “formed” and “accumulated” on the electrodes. Further, “wall voltage” refers to a potential difference formed on walls of the discharge cells.

FIG. 7 shows example of drive waveforms used to drive a plasma display panel according to an embodiment of the present invention.

Referring to FIG. 7, the reset period during which the discharge cells 18 are initialized is comprised of an ascending period and a descending period. In the ascending period, a voltage of the scan electrodes 21 is increased from Vs to Vset in a state where the sustain electrodes 23 and the address electrodes 12 are maintained at a reference voltage (0V). As a result, a weak reset discharge occurs from the scan electrodes 21 to each of the address electrodes 12 and the sustain electrodes 23, during which time negative wall charges are accumulated on the scan electrodes 21 and positive wall charges are accumulated on the address electrodes 12 and the sustain electrodes 23.

In addition, in the descending period of the reset period, the voltage of the scan electrodes 21 is reduced from Vs to Vnf. At this time, the reference voltage (0V in FIG. 7) is maintained in the address electrodes 12, and another voltage Ve is applied to the sustain electrodes 23, which creates weak discharge between the scan electrode 21 and the sustain electrode 23 and between the sustain electrode 23 and address electrode 12. As a result, during this time the negative wall charges formed on the scan electrodes 21 and the positive wall charges formed on the sustain electrodes 23 and the address electrodes 12 are removed. This foregoing process is called discharge cell initialization, and occurs in the entire discharge cells of the PDP device in the illustrated embodiment.

Subsequently, in order to select the discharge cells 18 to be turned on during the address period, a scan pulse having a VscL voltage and an address pulse having a Va voltage are applied to the scan electrodes 21 and the address electrodes 12. At this time, the VscL voltage is a scan voltage, and a VscH voltage is a non-scan voltage. The scan electrodes 21 that are not selected are biased by the VscH voltage, which is greater than the VscL voltage, and the reference voltage (0V) is applied to the address electrodes 12 of cells that are not to be turned on. As a result, a discharge cell is selected and address discharge occurs in the discharge cell when the corresponding address electrode is applied the Va voltage and the corresponding scan electrode is applied the VscL voltage. During the address discharge, positive wall charges are formed on the scan electrode, and negative wall charges are formed on the sustain electrode.

In one embodiment, a voltage Vs1 is alternatingly applied to the fourth and fifth electrodes 41a and 41b prior to the addressing of the scan electrode Yn (see FIG. 6). In one embodiment, the Vs1 voltage is greater than a discharge firing voltage between the fourth electrode 41a and the fifth electrode 41b to cause discharge between the fourth electrode 41a and the fifth electrode 41b in the auxiliary cell 40. In one embodiment, priming charges generated by this discharge are supplied to discharge cells where addressing occurs later. In one embodiment, the PDP device has one or more channels connecting the later-scanned discharge cells to the auxiliary cell 40 such that the priming charges created in the auxiliary cell 40 can be transferred to the later-scanned discharge cells to maintain a minimum level of priming charges in these discharge cells.

Although not illustrated, there are numerous other embodiments involving the discharge between the fourth electrode 41a and the fifth electrode 41b. For example, in one embodiment, Vs1 or another voltage may be applied to only at least one of the fourth electrode 41a and the fifth electrode 41b, or may be applied to each two times alternatingly. Further, in another embodiment, Vs1 or another voltage may be periodically applied to the fourth electrode 41a and the fifth electrode 41b in the address period. More particularly, Vs1 or another voltage may be applied to the fourth electrode 41a and the fifth electrode 41b every time a predetermined set of scan electrodes 23 are addressed during the address period. When Vs1 or a proper voltage is periodically applied to the fourth electrode 41a and the fifth electrode 41b in this manner, priming charges may be supplied to the lower portion of the PDP (e.g., the discharge cells 18 positioned close to the fourth electrode 41a or the fifth electrode 41b) more stably than when Vs1 is applied once to the fourth electrode 41a and the fifth electrode 41b.

Further, in other embodiments, in addition and/or in the alternative to applying Vs1, a reset pulse applied to the scan electrodes 21 during the reset period may be applied to the fourth electrode 41a and the fifth electrode 41b during the reset period or the address period. However, the reset pulse or signal for the fourth and fifth electrodes 41a and 41b may be the same in the waveform and the voltage or may be different from that applied to the scan electrodes 21. The reset signal for the fourth and fifth electrodes is configured to effect discharge between the fourth electrode 41a and the fifth electrode 41b so that priming charges can be created.

In further embodiments, pulses or signals are applied to either or both of the fourth electrode 41a and the fifth electrode 41b so as to effect discharge between the fourth electrode 41a and the address electrode 12 or between the fifth electrode 41b and the address electrode 12. In one embodiment, any arbitrary pulses that can effect discharge in the auxiliary cell may be applied. By using the discharge in the auxiliary cell and supplying priming charges to the later-scanned discharge cells, it is practicable to design PDP devices with a short scanning time for each row and overall short addressing time.

According to various embodiments of the present invention, an auxiliary cell is provided adjacent to the discharge cells where addressing occurs relatively late. Therefore, priming charges that are naturally eliminated with the passage of time are supplied from the auxiliary cell to the discharge cells where addressing occurs late.

Although an embodiment of the present invention has been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A plasma display panel device, comprising:
a display region comprising a plurality of rows of display discharge cells, each display discharge cell emitting visible light upon a plasma discharge therein, wherein the device is configured to sequentially scan each row during an address discharge period, and wherein the plurality of rows comprise a last row that is the last row scanned during the address discharge period; and
a non-display region comprising at least one non-display discharge cell, wherein the device is configured to generate a plasma discharge in the at least one non-display discharge cell prior to scanning the last row of display discharge cells.

2. The plasma display panel device of claim 1, wherein each display discharge cell comprises a phosphor layer formed on at least one interior surface thereof, and wherein the non-display discharge cell lacks a phosphor layer therein.

3. The plasma display panel device of claim 1, wherein the non-display region is located adjacent to the last row of display discharge cells.

4. The plasma display panel device of claim 1, further comprising a plurality of barrier ribs defining the display discharge cells and the non-display discharge cells.

5. The plasma display panel device of claim 1, wherein each non-display discharge cell has a surface area that is greater than that of each display discharge cell.

6. The plasma display panel device of claim 1, further comprising a pair of non-display electrodes formed over the at least one non-display discharge cell, wherein the pair of non-display electrodes is configured to generate a plasma discharge therebetween prior to scanning the last row of display discharge cells.

7. The plasma display panel of device claim 6, wherein the non-display electrodes are metallic.

8. The plasma display panel of device claim 6, wherein the display region and the non-display region are sandwiched between a front substrate and a rear substrate, and wherein the non-display electrodes are formed on the side of the front substrate.

9. The plasma display panel device of claim 1, wherein the device is configured to apply a potential difference between the pair of non-display electrodes to generate a plasma discharge in the at least one non-display discharge cell.

10. The plasma display panel device of claim 9, wherein the device is configured to apply the potential difference repeatedly during the address discharge period.

11. The plasma display panel device of claim 9, wherein the device is configured to periodically apply the potential difference during the address discharge period.

12. A method of operating a plasma display panel device, the method comprising
providing a plasma display device comprising a plurality of rows of display discharge cells and at least one non-display discharge cell, wherein each display discharge cell emits visible light upon a plasma discharge therein, and wherein the plurality of rows comprises a last row of display discharge cells;
initializing each display discharge cell;
selecting one or more display discharge cells during an address discharge period by generating a plasma discharge within the one or more display discharge cells, wherein selecting comprises scanning each row sequentially, and wherein the last row is the last row scanned during the address discharge period;
generating a plasma discharge within the at least one non-display discharge cell prior to scanning the last row during the address discharge period; and
continuing to generate a plasma discharge within the selected one or more display discharge cells during a sustain discharge period so as to emit visible light therefrom.

13. The method of claim 12, wherein scanning comprises sequentially applying a scan voltage to a plurality of scan electrodes.

14. The method of claim 12, wherein the plurality of rows comprises a next to last row, wherein the next to last row is scanned immediately prior to scanning the last row during the address discharge period, and wherein generating a plasma discharge within the at least one non-display discharge cell is carried out prior to scanning the next to last row during the address discharge period.

15. The method of claim 12, wherein the plasma display device further comprises a plurality of scan electrodes, a plurality of address electrodes, a plurality of sustain electrodes, and a pair of non-display discharge electrodes, wherein each scan electrode and each sustain electrode extend over one of the plurality of rows of display discharge cells, wherein each address electrode extends in a direction intersecting the plurality of scan electrodes, and wherein the pair of non-display discharge electrodes extends over the at least one non-display discharge cell.

16. The method of claim 15, wherein generating a plasma discharge within the at least one non-display discharge cell comprises applying a voltage difference between the pair of non-display discharge electrodes.

17. The method of claim 16, wherein the voltage difference is greater than a minimum discharge firing voltage of the at least one non-display discharge cell.

18. The method of claim 16, wherein applying the voltage difference between the pair of non-display discharge electrodes is repeated at an interval during the address discharge period.

19. The method of claim 16, wherein applying the voltage difference comprises applying a pulse of voltage to one of the pair of non-display discharge electrode while maintaining the other at a reference voltage.

20. The method of claim 16, wherein applying the voltage difference comprises applying a pulse of voltage during at least one of the address discharge period and a reset period for the initializing the display discharge cells.

21. A plasma display panel device, comprising:
a plurality of rows of discharge cells, each display discharge cell configured to emit visible light upon a plasma discharge therein, wherein the device is configured to sequentially scan each row during an address discharge period, and wherein the plurality of rows comprise a last row that is the last row scanned during the address discharge period; and
means for supplying charged particles to one or more discharge cells of the last row prior to scanning of the last row.

22. The device of claim 21, wherein the means comprises a discharge cell located in the vicinity of the last row and configured to create a plasma discharge therein.

23. The device of claim 22, wherein the discharge cell does not emit visible light.
